(19) United States
(12) Patent Application Publication
(10) Pub. No.: US 2025/0203478 A1
(43) Pub. Date: Jun. 19, 2025

(54) COMMUNICATION METHOD AND NETWORK NODE

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/065,704

(22) Filed: Feb. 27, 2025

Related U.S. Application Data
(63) Continuation of application No. PCT/JP2023/028768, filed on Aug. 7, 2023.

(30) Foreign Application Priority Data
Aug. 30, 2022 (JP) 2022-136419

(51) Int. Cl. H04W 36/14; H04W 8/22; H04W 36/36

(52) U.S. Cl. CPC H04W 36/142; H04W 8/22; H04W 36/362

(57) ABSTRACT

A communication method used in a mobile communication system includes: at a relay apparatus, relaying a radio signal, the relay apparatus being configured to change a propagation state of the radio signal without demodulating and modulating the radio signal transmitted between a first cell and a user equipment; and at a first network node corresponding to the first cell, transmitting a message for connecting the relay apparatus to a second cell to a second network node corresponding to the second cell over a network interface. The message includes information relating to the relay apparatus.

### RELATED APPLICATIONS

The present application is a continuation based on PCT Application No. PCT/JP2023/028768, filed on Aug. 7, 2023, which claims the benefit of Japanese Patent Application No. 2022-136419 filed on Aug. 30, 2022. The content of which is incorporated by reference herein in their entirety.

### TECHNICAL FIELD

The present disclosure relates to a communication method and a network node used in a mobile communication system.

### BACKGROUND

In recent years, a mobile communication system of the fifth generation (5G) has been attracting attention. New Radio (NR) that is a radio access technology of the 5G system can perform wide-band transmission via a high frequency band compared to Long Term Evolution (LTE) that is the fourth generation radio access technology.

Since radio signals (radio waves) in the high frequency band such as a millimeter wave band or a terahertz wave band have high rectilinearity, reduction of coverage of a base station is a problem. In order to solve such a problem, a repeater apparatus is attracting attention that is a kind of relay apparatuses that relay radio signals between a base station and a user equipment, and can be controlled from a network (see, for example, Non-Patent Document 1). Such a repeater apparatus can extend the coverage of the base station while suppressing occurrence of interference by, for example, amplifying a radio signal received from the base station and transmitting the radio signal through directional transmission.

### CITATION LIST

### Non-Patent Literature

Non-Patent Document 1: 3GPP Contribution: RP-213700, “New SI: Study on NR Network-controlled Repeaters”

### SUMMARY

In a first aspect, a communication method is a method used in a mobile communication system. The communication method includes: at a relay apparatus, relaying a radio signal, the relay apparatus being configured to change a propagation state of the radio signal without demodulating and modulating the radio signal transmitted between a first cell and a user equipment; and at a first network node corresponding to the first cell, transmitting a message for connecting the relay apparatus to a second cell to a second network node corresponding to the second cell over a network interface. The message includes information relating to the relay apparatus.

In a second aspect, a network node is an apparatus that corresponds to a first cell in a mobile communication system. The network node includes a transmitter configured to transmit a message to a second network node corresponding to a second cell over a network interface, the message being for connecting, to the second cell, a relay apparatus configured to change a propagation state of a radio signal without demodulating and modulating the radio signal transmitted between the first cell and a user equipment. The message includes information relating to the relay apparatus.

### BRIEF DESCRIPTION OF THE DRAWINGS

FIG. 1 is a diagram illustrating a configuration of a mobile communication system according to an embodiment.

FIG. 2 is a diagram illustrating a configuration of a protocol stack of a wireless interface of a user plane that handles data.

FIG. 3 is a diagram illustrating a configuration of a protocol stack of a wireless interface of a control plane that handles signaling (control signal).

FIG. 4 is a diagram illustrating an application scenario for a relay apparatus (NCR apparatus) according to a first embodiment.

FIG. 5 is a diagram illustrating an example of an application scenario for the relay apparatus (NCR apparatus) according to the first embodiment.

FIG. 6 is a diagram illustrating an example of a control method of the relay apparatus (NCR apparatus) according to the first embodiment.

FIG. 7 is a diagram illustrating a configuration example of a protocol stack in the mobile communication system that includes the relay apparatus (NCR apparatus) according to the first embodiment.

FIG. 8 is a diagram illustrating a configuration example of the relay apparatus (NCR apparatus) according to the first embodiment.

FIG. 9 is a diagram illustrating a configuration example of a base station (gNB) according to the embodiment.

FIG. 10 is a diagram illustrating an example of downlink signaling from the base station (gNB) to a control terminal (NCR-MT) according to the first embodiment.

FIG. 11 is a diagram illustrating an example of uplink signaling from the control terminal (NCR-MT) to the base station (gNB) according to the first embodiment.

FIG. 12 is a diagram illustrating an example of an entire operation sequence of the mobile communication system according to the first embodiment.

FIG. 13 is a diagram for describing beam sweeping according to the first embodiment.

FIG. 14 is a diagram for describing an operation relating to load balancing according to the first embodiment.

FIG. 15 is a diagram for describing a link (connection) between the NCR apparatus and the gNB according to the first embodiment.

FIG. 16 is a diagram illustrating an operation of the mobile communication system according to a first operation pattern.

FIG. 17 is a diagram illustrating the operation of the mobile communication system according to a second operation pattern.

FIG. 18 is a diagram illustrating the operation of the mobile communication system according to a third operation pattern.

FIG. 19 is a diagram for describing the relay apparatus (RIS apparatus) according to a second embodiment.

FIG. 20 is a diagram for describing the relay apparatus (RIS apparatus) according to the second embodiment.

### DESCRIPTION OF EMBODIMENTS

When a relay apparatus such as a repeater apparatus is controlled from a network, a control technique for specifically controlling the relay apparatus has not yet been established, and efficient coverage extension is currently difficult to perform using the relay apparatus.

The present disclosure enables appropriate control of a relay apparatus that performs relay transmission between a base station and a user equipment.

A mobile communication system according to embodiments will be described with reference to the drawings. In the description of the drawings, the same or similar parts are denoted by the same or similar reference signs.

### (1) First Embodiment

A first embodiment will be described first. The relay apparatus according to the first embodiment is a repeater apparatus that can be controlled from a network.

### (1.1) Overview of Mobile Communication System

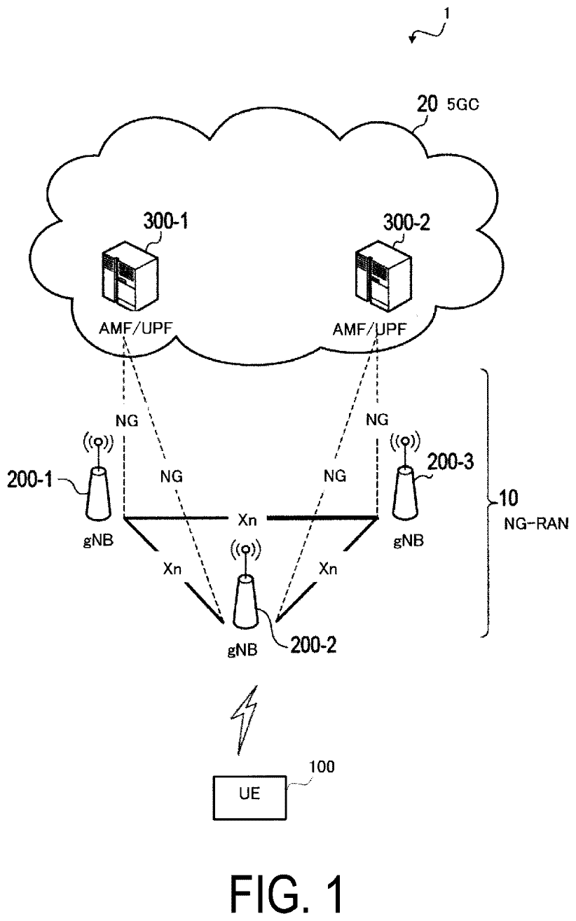

FIG. 1 is a diagram illustrating a configuration of a mobile communication system according to the first embodiment. A mobile communication system 1 complies with the 5th Generation System (5GS) of the 3rd Generation Partnership Project (3GPP) (registered trademark; the same applies below) standards. The description below takes the 5GS as an example, but Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (NG-RAN: Next Generation Radio Access Network) 10, and a 5G Core Network (5GC) 20. Hereinafter, the NG-RAN 10 will be also simply referred to as the RAN 10. The 5GC 20 will be also simply referred to as a Core Network (CN) 20.

The UE 100 is a movable wireless communication apparatus. The UE 100 may be any apparatus as long as the UE 100 is an apparatus used by a user. Examples of the UE 100 include a mobile phone terminal (including a smartphone) or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are connected with each other via an Xn interface that is an inter-base station interface. Each gNB 200 manages one or more cells. The gNB 200 performs wireless communication with the UE 100 that has established connection with the cell of the gNB 200. The gNB 200 has a Radio Resource Management (RRM) function, a function of routing user data (hereinafter simply referred to as “data”), a measurement control function for mobility control and scheduling, and the like. The “cell” is used as a term indicating a minimum unit of a wireless communication area. The “cell” is also used as a term indicating a function or a resource for performing wireless communication with the UE 100. One cell belongs to one carrier frequency (hereinafter simply referred to as a “frequency”).

Each gNB 200 may have functions divided into a Central Unit (CU) and a Distributed Unit (DU). The CU controls the DU. The CU is a unit that includes upper layers such as an RRC layer, an SDAP layer, and a PDCP layer included in a protocol stack to be described below. The CU is connected with the core network via an NG interface that is a backhaul interface. The CU is connected with a neighboring base station via an Xn interface that is an inter-base station interface. The DU forms a cell. Note that the DU is a unit that includes lower layers such as an RLC layer, a MAC layer, and a PHY layer included in the protocol stack to be described below. The DU is connected with the CU via an F1 interface that is a fronthaul interface.

Note that the gNB can be also connected with an Evolved Packet Core (EPC) corresponding to a core network of LTE. An LTE base station can be also connected with the 5GC. The LTE base station and the gNB can be also connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and the UPF are connected with the gNB 200 via an NG interface that is an interface between a base station and the core network.

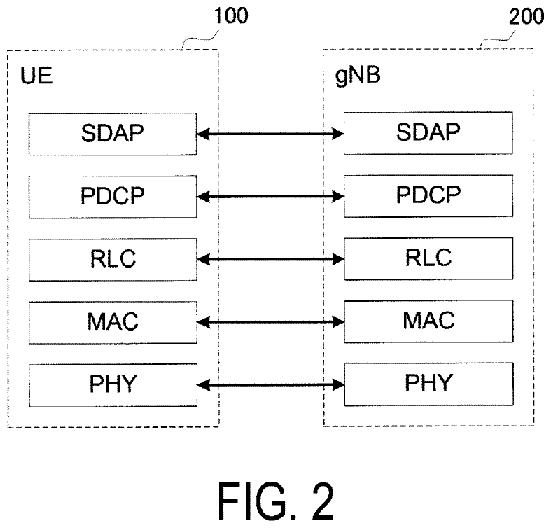

FIG. 2 is a diagram illustrating a configuration of a protocol stack of a wireless interface of a user plane that handles data.

A wireless interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives Downlink Control Information (DCI) transmitted from the gNB 200 over a Physical Downlink Control CHannel (PDCCH). More specifically, the UE 100 performs blind decoding of the PDCCH using a Radio Network Temporary Identifier (RNTI), and acquires successfully decoded DCI as DCI addressed to the UE 100. The DCI transmitted from the gNB 200 is appended with CRC parity bits scrambled by the RNTI.

The gNB 200 transmits a Synchronization Signal/PBCH Block (SSB). For example, the SSB includes four consecutive Orthogonal Frequency Division Multiplex (OFDM) symbols, and a Primary Synchronization Signal (PSS), a Secondary Synchronization Signal (SSS), a Physical Broadcast CHannel (PBCH)/Master Information Block (MIB), and a DeModulation Reference Signal (DMRS) of the PBCH are allocated therein. The bandwidth of the SSB is, for example, the bandwidth of 240 consecutive subcarriers, i.e., 20 RBs.

The MAC layer performs priority control of data, retransmission processing through Hybrid Automatic Repeat reQuest (HARQ: Hybrid ARQ), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes and Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow that is the unit of Quality of Service (QOS) control performed by a core network, and a radio bearer that is the unit of QoS control performed by an Access Stratum (AS). Note that, when the RAN is connected with the EPC, the SDAP may not be provided.

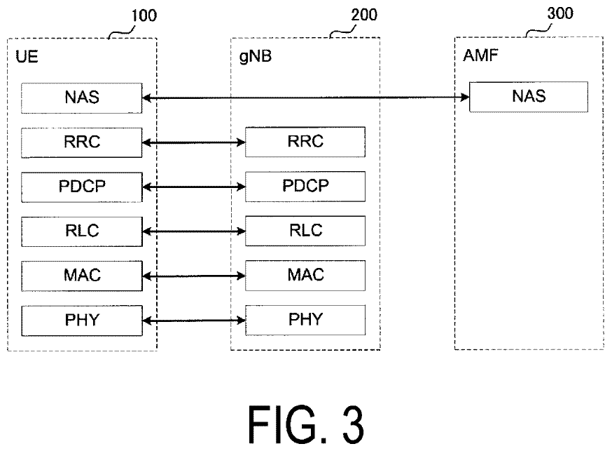

FIG. 3 is a diagram illustrating a configuration of a protocol stack of a wireless interface of a control plane that handles signaling (control signal).

The protocol stack of the wireless interface of the control plane includes a Radio Resource Control (RRC) layer and a Non-Access Stratum (NAS) layer instead of the SDAP layer illustrated in FIG. 2.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When connection (RRC connection) is established between the RRC of the UE 100 and the RRC of the gNB 200, the UE 100 is in an RRC connected state. When no connection (RRC connection) is established between the RRC of the UE 100 and the RRC of the gNB 200, the UE 100 is in an RRC idle state. When the connection between the RRC of the UE 100 and the RRC of the gNB 200 is suspended, the UE 100 is in an RRC inactive state.

The NAS layer positioned upper than the RRC layer performs session management, mobility management, and the like. NAS signaling is transmitted between the NAS layer of the UE 100 and the NAS layer of an AMF 300. Note that the UE 100 includes an application layer other than the protocol of the wireless interface. A layer lower than the NAS layer is referred to as an AS layer.

### (1.2) Example of Application Scenario for Relay Apparatus

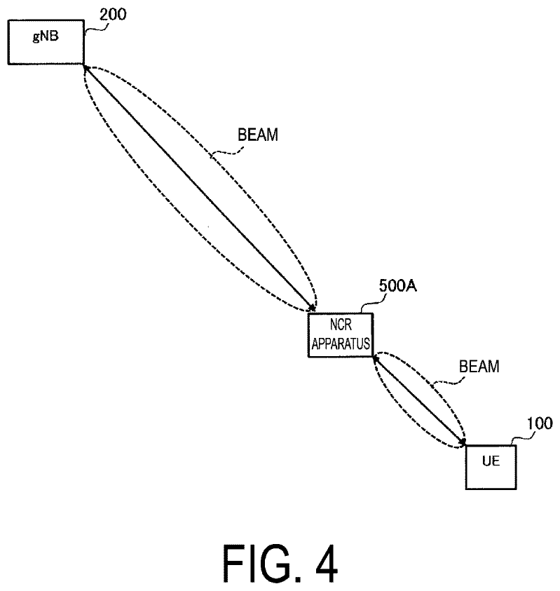

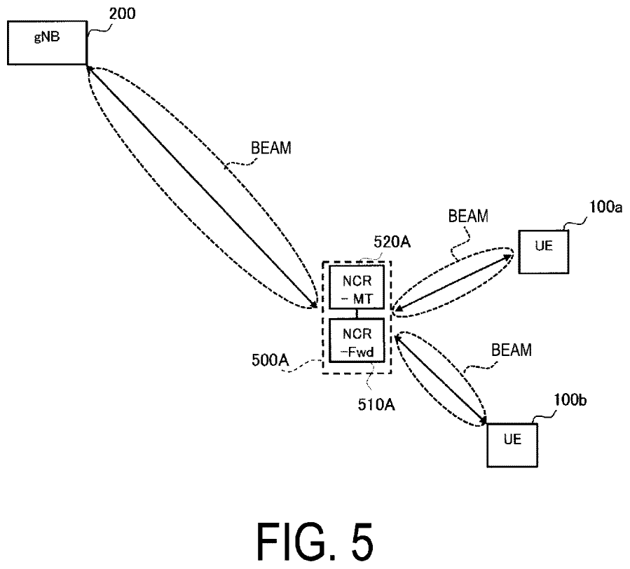

FIGS. 4 and 5 are diagrams illustrating examples of application scenarios for the NCR apparatus according to the first embodiment.

The 5G/NR can perform wide-band transmission in a high frequency band compared to the 4G/LTE. Since radio signals in the high frequency band such as a millimeter wave band or a terahertz wave band have high rectilinearity, a problem is reduction of coverage of the gNB 200. In FIG. 4, the UE 100 may be located at an outside of a coverage area of the gNB 200 such as an outside of an area in which the UE 100 can receive radio signals directly from the gNB 200. The UE 100 may not be able to communicate with the gNB 200 within a line of sight due to the presence of obstacles between the gNB 200 and the UE 100.

As illustrated in FIG. 4, a repeater apparatus (500A) is a type of a relay apparatus that relays radio signals between the gNB 200 and the UE 100, and can be controlled from the network. The repeater apparatus (500A) is introduced into the mobile communication system 1. Hereinafter, such a repeater apparatus will be referred to as a Network-Controlled Repeater (NCR) apparatus. Such a repeater apparatus may be referred to as a smart repeater apparatus.

For example, the NCR apparatus 500A amplifies a radio signal (radio wave) received from the gNB 200 and transmits the radio signal through directional transmission. More specifically, the NCR apparatus 500A receives a radio signal transmitted by the gNB 200 through beamforming. The NCR apparatus 500A amplifies the received radio signal without demodulating or modulating the radio signal, and transmits the amplified radio signal through the directional transmission. Here, the NCR apparatus 500A may transmit the radio signal with a fixed directivity (beam). The NCR apparatus 500A may transmit a radio signal with a variable (adaptive) directional beam. Thus, the coverage of the gNB 200 can be efficiently extended. Although it is assumed in the first embodiment that the NCR apparatus 500A is applied to downlink communication from the gNB 200 to the UE 100, the NCR apparatus 500A can be also applied to uplink communication from the UE 100 to the gNB 200.

As illustrated in FIG. 5, a new UE (hereinafter referred to as an “NCR-Mobile Terminal (MT)”) 100b is introduced that is a type of the control terminal for controlling the NCR apparatus 500A. That is, the NCR apparatus 500A includes an NCR-Forward (Fwd) 510A that is a kind of a repeater that relays a radio signal to be transmitted between the gNB 200 and the UE 100, more specifically, changes a propagation state of the radio signal without demodulating or modulating the radio signal, and an NCR-MT 520A that performs wireless communication with the gNB 200 to control the NCR-Fwd 510A. As described above, the NCR-MT 520A controls the NCR apparatus 500A in cooperation with the gNB 200 by establishing wireless connection with the gNB 200 and performing wireless communication with the gNB 200. Thus, the coverage can be efficiently extended using the NCR apparatus 500A. The NCR-MT 520A controls the NCR apparatus 500A under control of the gNB 200.

The NCR-MT 520A may be configured separately from the NCR-Fwd 510A. For example, the NCR-MT 520A may be located near the NCR-Fwd 510A and electrically connected with the NCR-Fwd 510A. The NCR-MT 520A may be connected with the NCR-Fwd 510A by wire or wirelessly. The NCR-MT 520A may be configured to be integrated with the NCR-Fwd 510A. The NCR-MT 520A and the NCR-Fwd 510A may be fixedly installed at a coverage edge (cell edge) of the gNB 200, or on a wall surface or a window of any building, for example. The NCR-MT 520A and the NCR-Fwd 510A may be installed in, for example, a vehicle to be movable. The one NCR-MT 520A may control a plurality of the NCR-Fwds 510A.

In the example illustrated in FIG. 5, the NCR apparatus 500A (NCR-Fwd 510A) dynamically or semi-statically changes a beam to be transmitted or received. For example, the NCR-Fwd 510A forms a beam toward each of a UE 100a and a UE 100b. The NCR-Fwd 510A may also form a beam toward the gNB 200. For example, in a communication resource between the gNB 200 and the UE 100a, the NCR-Fwd 510A transmits a radio signal received from the gNB 200 toward the UE 100a through beamforming, and/or transmits a radio signal received from the UE 100a toward the gNB 200 through beamforming. In a communication resource between the gNB 200 and the UE 100b, the NCR-Fwd 510A transmits a radio signal received from the gNB 200 toward the UE 100b through beamforming, and/or transmits a radio signal received from the UE 100b toward the gNB 200 through beamforming. Instead of beamforming or in addition to beamforming, the NCR-Fwd 510A may perform null forming (so-called null steering) toward the UE 100 (not illustrated) that is not a communication partner and/or the neighboring gNB 200 (not illustrated) to suppress the interference.

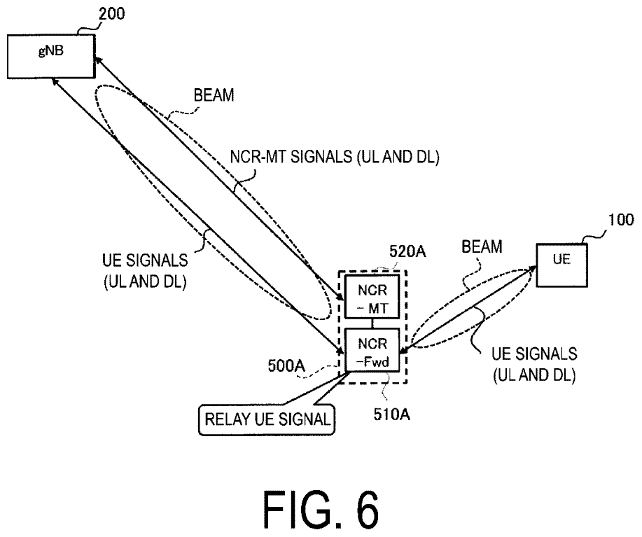

FIG. 6 is a diagram illustrating an example of a control method of the NCR apparatus 500A according to the first embodiment. As illustrated in FIG. 6, the NCR-Fwd 510A relays a radio signal (also referred to as a “UE signal”) between the gNB 200 and the UE 100. The UE signal includes an uplink signal (also referred to as a “UE-UL signal”) transmitted from the UE 100 to the gNB 200 and a downlink signal (also referred to as a “UE-DL signal”) transmitted from the gNB 200 to the UE 100. The NCR-Fwd 510A relays the UE-UL signal from the UE 100 to the gNB 200 and relays the UE-DL signal from the gNB 200 to the UE 100. The radio link between the NCR-Fwd 510A and the UE 100 will be also referred to as an “access link”. The radio link between the NCR-Fwd 510A and the gNB 200 will be also referred to as a “backhaul link”.

The NCR-MT 520A transmits and receives radio signals (hereinafter referred to as “NCR-MT signals”) to and from the gNB 200. The NCR-MT signal includes an uplink signal (referred to as an “NCR-MT-UL signal”) transmitted from the NCR-MT 520A to the gNB 200, and a downlink signal (referred to as an “NCR-MT-DL signal”) transmitted from the gNB 200 to the NCR-MT 520A. The NCR-MT-UL signal includes signaling for controlling the NCR apparatus 500A. The radio link between the NCR-MT 520A and the gNB 200 will be also referred to as a “control link”

The gNB 200 directs a beam to the NCR-MT 520A based on the NCR-MT-UL signal from the NCR-MT 520A. The NCR apparatus 500A and the NCR-MT 520A are co-located, and, when the frequency is the same between the backhaul link and the control link, and the gNB 200 directs a beam to the NCR-MT 520A, the beam is also eventually directed to the NCR-Fwd 510A. The gNB 200 transmits the NCR-MT-DL signal and the UE-DL signal using the beam. The NCR-MT 520A receives the NCR-MT-DL signal. Note that, when the NCR-Fwd 510A and the NCR-MT 520A are at least partially integrated, functions (e.g., antennas) of transmitting and receiving or relaying UE signals and/or NCR-MT signals may be integrated in the NCR-Fwd 510A and the NCR-MT 520A. Note that the beam includes a transmission beam and/or a reception beam. The beam is a general term for transmission and/or reception under control for maximizing power of a transmission wave and/or a reception wave in a specific direction by adjusting/adapting an antenna weight or the like.

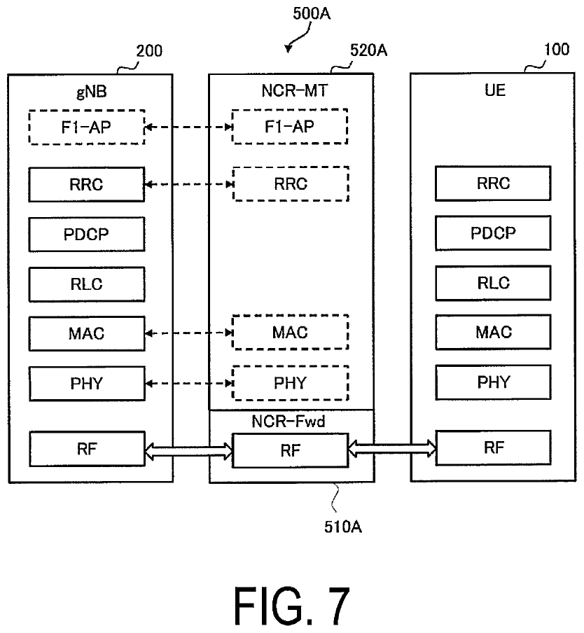

FIG. 7 is a diagram illustrating a configuration example of a protocol stack in the mobile communication system 1 that includes the NCR apparatus 500A according to the first embodiment. The NCR-Fwd 510A relays a radio signal transmitted and received between the gNB 200 and the UE 100. The NCR-Fwd 510A has a Radio Frequency (RF) function of amplifying and relaying a received radio signal, and performs directional transmission through beamforming (e.g., analog beamforming).

The NCR-MT 520A includes at least one layer (entity) selected from the group consisting of PHY, MAC, RRC, and F1-Application Protocol (AP). The F1-AP is a type of a fronthaul interface. The NCR-MT 520A communicates downlink signaling and/or uplink signaling to be described below with the gNB 200 through at least one selected from the group consisting of the PHY, the MAC, the RRC, and the F1-AP. When the NCR-MT 520A is a type or a part of the base station, the NCR-MT 520A may communicate with the gNB 200 through an AP of Xn (Xn-AP) that is an inter-base station interface.

### (1.3) Configuration Example of Relay Apparatus

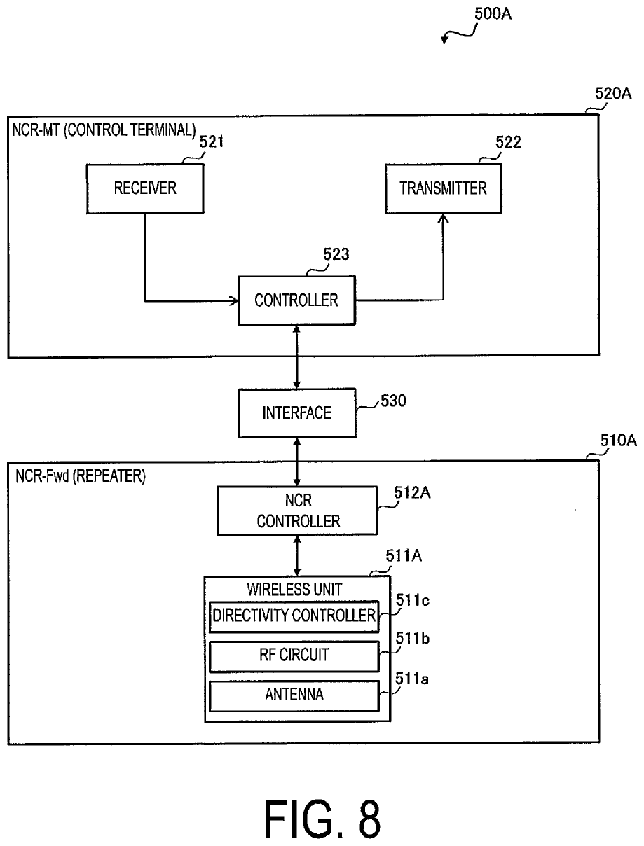

FIG. 8 is a diagram illustrating a configuration example of the NCR apparatus 500A that is the relay apparatus according to the first embodiment. The NCR apparatus 500A includes the NCR-Fwd 510A, the NCR-MT 520A, and an interface 530.

The NCR-Fwd 510A includes a wireless unit 511A and an NCR controller 512A. The wireless unit 511A includes an antenna 511a that includes a plurality of antennas (a plurality of antenna elements), an RF circuit 511b that includes an amplifier, and a directivity controller 511c that controls directivity of the antenna 511a. The RF circuit 511b amplifies and relays (transmits) radio signals transmitted and received by the antenna 511a. The RF circuit 511b may convert a radio signal that is an analog signal into a digital signal, and reconvert the digital signal into an analog signal after digital signal processing. The directivity controller 511c may perform analog beamforming by analog signal processing. The directivity controller 511c may perform digital beamforming by digital signal processing. The directivity controller 511c may perform analog and digital hybrid beamforming. The NCR controller 512A controls the wireless unit 511A in response to a control signal from the NCR-MT 520A. The NCR controller 512A may include at least one processor. The NCR controller 512A may output information relating to capability of the NCR apparatus 500A to the NCR-MT 520A.

The NCR-MT 520A includes a receiver 521, a transmitter 522, and a controller 523. The receiver 521 performs various types of reception under control of the controller 523. The receiver 521 includes an antenna and a reception device. The reception device converts a radio signal (radio signal) received through the antenna into a baseband signal (received signal), and outputs the baseband signal to the controller 523. The transmitter 522 performs various types of transmission under control of the controller 523. The transmitter 522 includes an antenna and a transmission device. The transmission device converts a baseband signal (transmission signal) output by the controller 523 into a radio signal, and transmits the radio signal through the antenna. The controller 523 performs various types of control for the NCR-MT 520A. The controller 523 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like on a baseband signal. The CPU executes the program stored in the memory and performs various types of processing. The controller 523 executes a function of at least one layer selected from the group consisting of the PHY, the MAC, the RRC, and the F1-AP.

The interface 530 electrically connects the NCR-Fwd 510A and the NCR-MT 520A. The controller 523 of the NCR-MT 520A controls the NCR-Fwd 510A via the interface 530.

In the first embodiment, the receiver 521 of the NCR-MT 520A receives signaling (downlink signaling) used to control the NCR apparatus 500A from the gNB 200 by wireless communication. The controller 523 of the NCR-MT 520A controls the NCR apparatus 500A based on the signaling. Thus, the gNB 200 can control the NCR-Fwd 510A via the NCR-MT 520A.

In the first embodiment, the controller 523 of the NCR-MT 520A may transmit the NCR capability information indicating the capability of the NCR apparatus 500A to the gNB 200 by wireless communication. The NCR capability information is an example of the uplink signaling from the NCR-MT 520A to the gNB 200. Thus, the gNB 200 can recognize the capability of the NCR apparatus 500A.

### (1.4) Configuration Example of Base Station

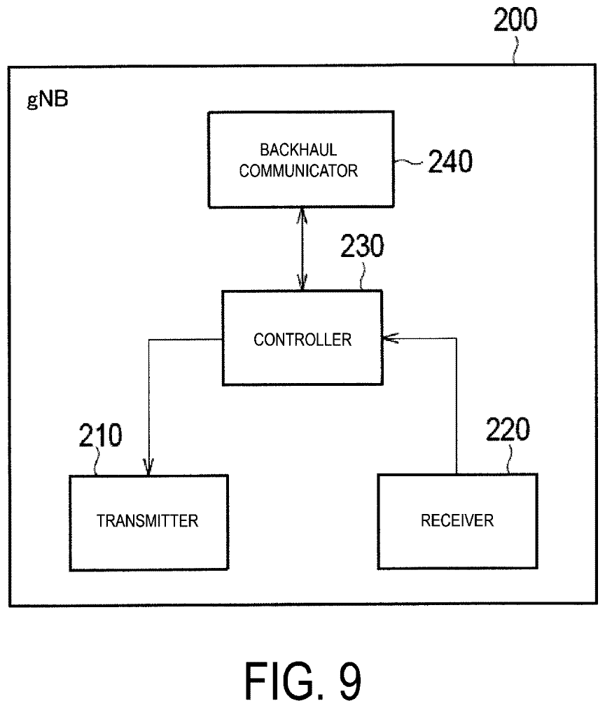

FIG. 9 is a diagram illustrating a configuration example of the gNB 200 according to the first embodiment. The gNB 200 includes a transmitter 210, a receiver 220, a controller 230, and a backhaul communicator 240.

The transmitter 210 performs various types of transmission under control of the controller 230. The transmitter 210 includes an antenna and a transmission device. The transmission device converts a baseband signal (transmission signal) output by the controller 230 into a radio signal, and transmits the radio signal through the antenna. The receiver 220 performs various types of reception under control of the controller 230. The receiver 220 includes an antenna and a reception device. The reception device converts a radio signal received through the antenna into a baseband signal (received signal), and outputs the baseband signal to the controller 230. The transmitter 210 and the receiver 220 may be capable of beamforming using a plurality of antennas.

The controller 230 performs various types of control for the gNB 200. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like on a baseband signal. The CPU executes the program stored in the memory and performs various types of processing.

The backhaul communicator 240 is connected with a neighboring base station via the inter-base station interface. The backhaul communicator 240 is connected with the AMF/UPF 300 via the interface between a base station and the core network. Note that the gNB may include a Central Unit (CU) and a Distributed Unit (DU) (i.e., functions are divided), and both units may be connected via an F1 interface.

In the first embodiment, the transmitter 210 of the gNB 200 transmits signaling (downlink signaling) used to control the NCR-Fwd 510A to the NCR-MT 520A by wireless communication. Thus, the gNB 200 can control the NCR apparatus 500A via the NCR-MT 520A. In the first embodiment, the receiver 220 of the gNB 200 receives the NCR capability information indicating the capability of the NCR apparatus 500A from the NCR-MT 520A by wireless communication.

### (1.5) Example of Downlink Signaling

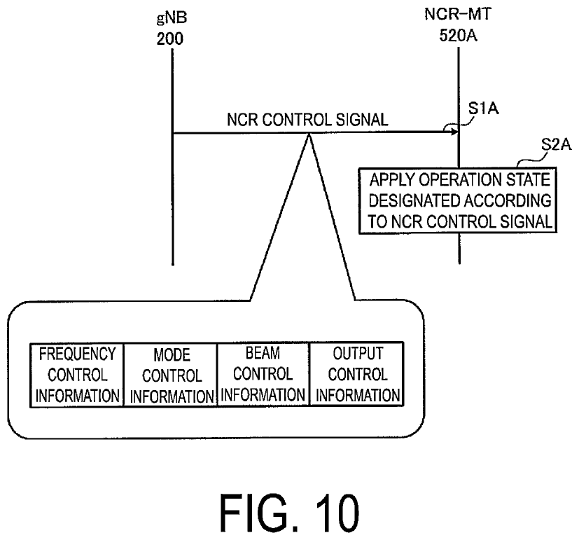

FIG. 10 is a diagram illustrating an example of the downlink signaling from the gNB 200 to the NCR-MT 520A according to the first embodiment.

The gNB 200 (transmitter 210) transmits downlink signaling to the NCR-MT 520A. The downlink signaling may be an RRC message that is RRC layer (i.e., layer 3) signaling. The downlink signaling may be a MAC Control Element (CE) that is MAC layer (i.e., layer 2) signaling. The downlink signaling may be Downlink Control Information (DCI) that is PHY layer (i.e., layer 1) signaling. The downlink signaling may be UE-specific signaling. The downlink signaling may be broadcast signaling. The downlink signaling may be a fronthaul message (e.g., F1-AP message). When the NCR-MT 520A is a type or a part of the base station, the NCR-MT 520A may communicate with the gNB 200 through the AP of Xn (Xn-AP) that is the inter-base station interface.

For example, the gNB 200 (transmitter 210) transmits an NCR control signal for designating an operation state of the NCR apparatus 500A as the downlink signaling to the NCR-MT 520A that has established wireless connection with the gNB 200 (step S1A). The NCR control signal for designating the operation state of the NCR apparatus 500A may be the MAC CE that is the MAC layer (layer 2) signaling or the DCI that is the PHY layer (layer 1) signaling. In this regard, the gNB 200 (transmitter 210) may include the NCR control signal in an RRC Reconfiguration message that is a type of a UE-specific RRC message to transmit to the NCR-MT 520A. The downlink signaling may be a message of a layer (e.g., NCR application) upper than the RRC layer. The downlink signaling may be encapsulating a message of a layer upper than the RRC layer with a message of a layer equal to or lower than the RRC layer, and transmitting the message. Note that the NCR-MT 520A (transmitter 522) may transmit in the uplink a response message to the downlink signaling from the gNB 200. The response message may be transmitted in response to that the NCR apparatus 500A has completed the configuration designated by the downlink signaling or received the configuration. The NCR control signal may be also referred to as Side Control Information.

The NCR control signal may include frequency control information for designating a center frequency of a radio signal (e.g., component carrier) that is a relay target of the NCR-Fwd 510A. When the NCR control signal received from the gNB 200 includes the frequency control information, the NCR-MT 520A (controller 523) controls the NCR-Fwd 510A such that a radio signal of the center frequency indicated by the frequency control information is relayed as the target (step S2A). The NCR control signal may include a plurality of pieces of frequency control information for designating center frequencies different from each other. Since the NCR control signal includes the frequency control information, the gNB 200 can designate the center frequency of the radio signal that is the relay target of the NCR-Fwd 510A via the NCR-MT 520A.

The NCR control signal may include mode control information for designating an operation mode of the NCR-Fwd 510A. The mode control information may be associated with the frequency control information (center frequency). The operation mode may be any one of a mode in which the NCR-Fwd 510A performs non-directional transmission and/or reception, a mode in which the NCR-Fwd 510A performs fixed directional transmission and/or reception, a mode in which the NCR-Fwd 510A performs transmission and/or reception with a variable directional beam, and a mode in which the NCR-Fwd 510A performs Multiple Input Multiple Output (MIMO) relay transmission. The operation mode may be either a beamforming mode (i.e., a mode in which improvement of a desired wave is prioritized) or a null steering mode (i.e., a mode in which suppression of an interference wave is prioritized). When the NCR control signal received from the gNB 200 includes the mode control information, the NCR-MT 520A (controller 523) controls the NCR-Fwd 510A such that the NCR-Fwd 510A operates in the operation mode indicated by the mode control information (step S2A). The NCR control signal includes the mode control information, so that the gNB 200 can designate the operation mode of the NCR-Fwd 510A via the NCR-MT 520A.

Here, the mode in which the NCR apparatus 500A performs non-directional transmission and/or reception is a mode in which the NCR-Fwd 510A performs relay in all directions and may be referred to as an omnidirectional mode. The mode in which the NCR-Fwd 510A performs fixed directional transmission and/or reception may be a directivity mode implemented by one directional antenna. The mode may be a beamforming mode implemented by applying fixed phase and amplitude control (antenna weight control) to a plurality of antennas. Any of these modes may be designated (configured) from the gNB 200 to the NCR-MT 520A. The mode in which the NCR-Fwd 510A performs transmission and/or reception with a variable directional beam may be a mode for performing analog beamforming. The mode may be a mode for performing digital beamforming. The mode may be a mode for performing hybrid beamforming. The mode may be a mode for forming an adaptive beam specific to the UE 100. Any of these modes may be designated (configured) from the gNB 200 to the NCR-MT 520A. Note that, in the operation mode for performing beamforming, beam control information described below may be provided from the gNB 200 to the NCR-MT 520A. The mode in which the NCR apparatus 500A performs MIMO relay transmission may be a mode for performing Single-User (SU) spatial multiplexing. The mode may be a mode for performing Multi-User (MU) spatial multiplexing. The mode may be a mode for performing transmission diversity. Any of these modes may be designated (configured) from the gNB 200 to the NCR-MT 520A. The operation mode may include a mode in which the NCR-Fwd 510A turns on (activates) relay transmission, and a mode in which the NCR-Fwd 510A turns off (deactivates) relay transmission. Any of these modes may be designated (configured) from the gNB 200 to the NCR-MT 520A using the NCR control signal.

The NCR control signal may include the beam control information for designating a transmission direction, a transmission weight, or a beam pattern at a time when the NCR-Fwd 510A performs directional transmission. The beam control information may be associated with the frequency control information (center frequency). The beam control information may include a Precoding Matrix Indicator (PMI). The beam control information may include beam forming angle information. When the NCR control signal received from the gNB 200 includes the beam control information, the NCR-MT 520A (controller 523) controls the NCR-Fwd 510A such that the NCR-Fwd 510A forms a transmission directivity (beam) indicated by the beam control information (step S2A). The NCR control signal includes the beam control information, so that the gNB 200 can control the transmission directivity of the NCR apparatus 500A via the NCR-MT 520A.

The NCR control signal may include output control information for designating the degree (amplification gain) of amplifying a radio signal by the NCR-Fwd 510A or transmission power. The output control information may be information indicating a difference value (i.e., relative value) between the current amplification gain or transmission power and the target amplification gain or transmission power. When the NCR control signal received from the gNB 200 includes the output control information, the NCR-MT 520A (controller 523) controls the NCR-Fwd 510A such that the NCR-Fwd 510A changes the amplification gain or transmission power to an amplification gain or transmission power indicated by the output control information (step S2A). The output control information may be associated with the frequency control information (center frequency). The output control information may be information for designating any one of an amplification gain, a beamforming gain, and an antenna gain of the NCR-Fwd 510A. The output control information may be information for designating the transmission power of the NCR-Fwd 510A.

When the one NCR-MT 520A controls the plurality of the NCR-Fwds 510A, the gNB 200 (transmitter 210) may transmit the NCR control signal for each of the NCR-Fwds 510A to the NCR-MT 520A. In this case, the NCR control signal may include an identifier of the corresponding NCR-Fwd 510A (NCR identifier). The NCR-MT 520A (controller 523) that controls the plurality of NCR-Fwds 510A determines the NCR-Fwd 510A to which the NCR control signal is applied, based on the NCR identifier included in the NCR control signal received from the gNB 200. Note that the NCR identifier may be transmitted together with the NCR control signal from the NCR-MT 520A to the gNB 200 even when the NCR-MT 520A controls only the one NCR-Fwd 510A.

As described above, the NCR-MT 520A (controller 523) controls the NCR-Fwd 510A based on the NCR control signal from the gNB 200. Thus, the gNB 200 can control the NCR-Fwd 510A via the NCR-MT 520A.

### (1.6) Example of Uplink Signaling

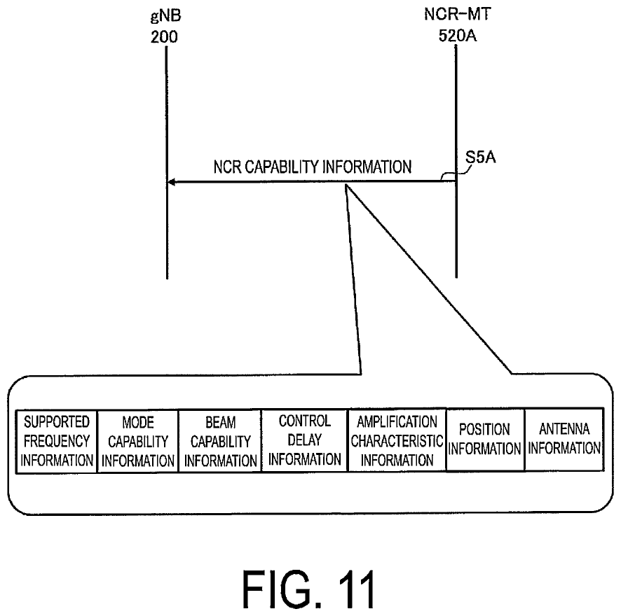

FIG. 11 is a diagram illustrating an example of the uplink signaling from the NCR-MT 520A to the gNB 200 according to the first embodiment.

The NCR-MT 520A (transmitter 210) transmits uplink signaling to the gNB 200. The uplink signaling may be an RRC message that is RRC layer signaling. The uplink signaling may be a MAC CE that is MAC layer signaling. The uplink signaling may be Uplink Control Information (UCI) that is PHY layer signaling. The uplink signaling may be a fronthaul message (e.g., F1-AP message). The uplink signaling may be an inter-base station message (e.g., Xn-AP message). The uplink signaling may be a message of a layer (e.g., NCR application) upper than the RRC layer. The uplink signaling may be encapsulating a message of a layer upper than the RRC layer with a message of a layer equal to or lower than the RRC layer, and transmitting the message. That is, the uplink signaling stores an upper layer message in a lower layer container. Note that the gNB 200 (transmitter 210) may transmit in the downlink a response message to the uplink signaling from the NCR-MT 520A, and the NCR-MT 520A (receiver 521) may receive the response message.

For example, the NCR-MT 520A (transmitter 522) having established wireless connection with the gNB 200 transmits the NCR capability information indicating the capability of the NCR apparatus 500A as the uplink signaling to the gNB 200 (step S5A). The NCR-MT 520A (transmitter 522) may include the NCR capability information in a UE Capability message or a UE Assistant Information message that is a type of the RRC message to transmit to the gNB 200. The NCR-MT 520A (transmitter 522) may transmit the NCR capability information (NCR capability information and/or operation state information) to the gNB 200 in response to a request or an inquiry from the gNB 200.

The NCR capability information may include supported frequency information indicating a frequency supported by the NCR-Fwd 510A. The supported frequency information may be a numerical value or an index indicating a center frequency of the frequency supported by the NCR-Fwd 510A. The supported frequency information may be a numerical value or an index indicating a range of the frequencies supported by the NCR-Fwd 510A. When the NCR capability information received from the NCR-MT 520A includes the supported frequency information, the gNB 200 (controller 230) can recognize the frequency supported by the NCR-Fwd 510A based on the supported frequency information. The gNB 200 (controller 230) may configure the center frequency of the radio signal targeted by the NCR apparatus 500A within the range of the frequencies supported by the NCR-Fwd 510A.

The NCR capability information may include mode capability information relating to the operation modes or switching between the operation modes that can be supported by the NCR-Fwd 510A. As described above, the operation mode may be at least any one selected from the group consisting of a mode in which the NCR-Fwd 510A performs non-directional transmission and/or reception, a mode in which the NCR-Fwd 510A performs fixed directional transmission and/or reception, a mode in which the NCR-Fwd 510A performs transmission and/or reception with a variable directional beam, and a mode in which the NCR-Fwd 510A performs Multiple Input Multiple Output (MIMO) relay transmission. The operation mode may be either the beamforming mode (i.e., the mode in which improvement of a desired wave is prioritized) or the null steering mode (i.e., a mode in which suppression of an interference wave is prioritized). The mode capability information may be information indicating which operation mode among these operation modes the NCR-Fwd 510A can support. The mode capability information may be information indicating between which operation modes among these operation modes the mode switching is possible. When the NCR capability information received from the NCR-MT 520A includes the mode capability information, the gNB 200 (controller 230) can recognize the operation modes and mode switching supported by the NCR-Fwd 510A based on the mode capability information. The gNB 200 (controller 230) may configure the operation mode of the NCR-Fwd 510A within a range of the recognized operation modes and mode switching.

The NCR capability information may include the beam capability information indicating a beam variable range, a beam variable resolution, or the number of variable patterns at a time when the NCR-Fwd 510A performs transmission and/or reception with a variable directional beam. The beam capability information may be, for example, information indicating a variable range of a beam angle (that can be controlled between, for example, 30° and 90°) for which the horizontal direction or the vertical direction is used as a reference. The beam capability information may be information indicating an absolute angle. The beam capability information may be expressed as a direction and/or an elevation angle at which a beam is directed. The beam capability information may be information indicating an angular change for each variable step (e.g., horizontal 5°/step, vertical 10°/step). The beam capability information may be information indicating the number of variable steps (e.g., horizontal 10 steps and vertical 20 steps). The beam capability information may be information indicating the number of variable patterns of a beam in the NCR-Fwd 510A (e.g., 10 patterns of beam patterns 1 to 10 in total). When the NCR capability information received from the NCR-MT 520A includes the beam capability information, the gNB 200 (controller 230) can recognize the beam angle change or beam patterns that can be supported by the NCR-Fwd 510A based on the beam capability information. The gNB 200 (controller 230) may configure a beam of the NCR-Fwd 510A within a range of the recognized beam angular change or beam patterns. These pieces of beam capability information may be null capability information. In a case of the null capability information, these pieces of beam capability information indicate null control capability at a time when null steering is performed.

The NCR capability information may include control delay information indicating a control delay time in the NCR apparatus 500A. For example, the control delay information is information indicating a delay time (e.g., 1 ms, 10 ms, and . . . ) from a timing at which the UE 100 receives an NCR control signal or a timing at which the UE 100 transmits configuration completion for the NCR control signal to the gNB 200 to completion of control (change of the operation mode and/or change of the beam) according to the NCR control signal. When the NCR capability information received from the NCR-MT 520A includes the control delay information, the gNB 200 (controller 230) can recognize the control delay time in the NCR-Fwd 510A based on the control delay information.

The NCR capability information may include amplification characteristics information relating to amplification characteristics or output power characteristics of the radio signal in the NCR-Fwd 510A. The amplification characteristics information may be information indicating an amplifier gain (dB), a beamforming gain (dB), and an antenna gain (dBi) of the NCR-Fwd 510A. The amplification characteristics information may be information indicating an amplification variable range (e.g., 0 dB to 60 dB) in the NCR-Fwd 510A. The amplification characteristics information may be information indicating the number of steps (e.g., 10 steps) of the amplification degrees that can be changed by the NCR-Fwd 510A or the amplification degree for each variable step (e.g., 10 dB/step). The amplification characteristics information may be information indicating an output power variable range (e.g., 0 dBm to 30 dBm) of the NCR-Fwd 510A. The amplification characteristics information may be information indicating the number of steps (e.g., 10 steps) of the output power that can be changed by the NCR-Fwd 510A or the output power for each variable step (e.g., 10 dBm/step or 10 dB/step).

The NCR capability information may include position information indicating an installation position of the NCR apparatus 500A. The position information may include any one or more of a latitude, a longitude, and an altitude. The position information may include information indicating a distance and/or an installation angle of the NCR apparatus 500A for which the gNB 200 is used as the reference. The installation angle may be a relative angle with respect to the gNB 200, or a relative angle for which, for example, north, vertical, or horizontal is used as the reference. The installation position may be position information of a place at which the antenna 511a of the NCR-Fwd 510A is installed.

The NCR capability information may include antenna information indicating the number of antennas included in the NCR-Fwd 510A. The antenna information may be information indicating the number of antenna ports included in the NCR-Fwd 510A. The antenna information may be information indicating a degree of freedom of the directivity control (beam or null formation). The degree of freedom indicates how many beams can be formed (controlled) and is usually “(the number of antennas)−1”. For example, in the case of two antennas, the degree of freedom is one. In the case of the two antennas, an 8-shaped beam pattern is formed, but the directivity control can be performed only in one direction, so that the degree of freedom is one.

When the NCR-MT 520A controls the plurality of NCR-Fwds 510A, the NCR-MT 520A (transmitter 522) may transmit the NCR capability information for each NCR-Fwd 510A to the gNB 200. In this case, the NCR capability information may include the number of the NCR-Fwds 510A and/or an identifier of the corresponding NCR-Fwd 510A (NCR identifier). When the NCR-MT 520A controls the plurality of NCR-Fwds 510A, the NCR-MT 520A (transmitter 522) may transmit information indicating the respective identifiers of the plurality of NCR-Fwds 510A and/or the number of the plurality of NCR-Fwds 510A. Note that the NCR identifier may be transmitted together with the NCR capability information from the NCR-MT 520A to the gNB 200 even when the NCR-MT 520A controls only the one NCR-Fwd 510A.

### (1.7) Example of Entire Operation Sequence

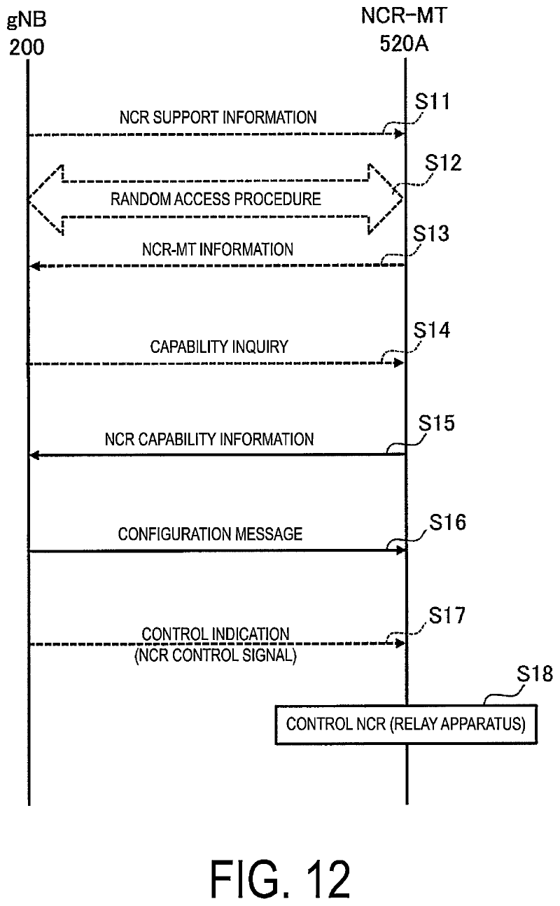

FIG. 12 is a diagram illustrating an example of an entire operation sequence of the mobile communication system 1 according to the first embodiment. In the sequence diagram referred to in the following embodiment, broken lines indicate non-essential steps. Note that, although details will be described below, “NCR” in FIG. 12 may be read as “RIS”.

In step S11, the gNB 200 (transmitter 210) broadcasts NCR support information indicating that the gNB 200 supports the NCR-MT 520A. For example, the gNB 200 (transmitter 210) broadcasts a System Information Block (SIB) including the NCR support information. The NCR support information may be information indicating that the NCR-MT 520A is accessible. The gNB 200 (transmitter 210) may broadcast NCR non-support information indicating that the gNB 200 does not support the NCR-MT 520A. The NCR non-support information may be information indicating that the NCR-MT 520A is inaccessible.

At this stage, the NCR-MT 520A may be in the RRC idle state or the RRC inactive state. The NCR-MT 520A (controller 523) that has not established wireless connection with the gNB 200 may determine that access to the gNB 200 is permitted in response to reception of the NCR support information from the gNB 200, and perform an access operation for establishing wireless connection with the gNB 200. The NCR-MT 520A (controller 523) may regard the gNB 200 (cell) to which access is permitted as the highest priority and perform cell reselection.

On the other hand, when the gNB 200 does not broadcast the NCR support information (or when the gNB 200 broadcasts the NCR non-support information), the NCR-MT 520A (controller 523) that has not established wireless connection with the gNB 200 may determine that access (connection establishment) to the gNB 200 is not possible. Thus, the NCR-MT 520A can establish wireless connection only to the gNB 200 that can handle the NCR-MT 520A.

Note that, when the gNB 200 is congested, the gNB 200 may broadcast access restriction information for restricting access from the UE 100. However, unlike the normal UE 100, the NCR-MT 520A can be also regarded as a network-side entity. Hence, the NCR-MT 520A may ignore the access restriction information from the gNB 200. When, for example, receiving the NCR support information from the gNB 200, the NCR-MT 520A (controller 523) may perform an operation of establishing wireless connection with the gNB 200 even if the gNB 200 broadcasts the access restriction information. For example, the NCR-MT 520A (controller 523) may not execute (or may ignore) Unified Access Control (UAC). Any one or both of Access Category/Access Identity (AC/AI) used in the UAC may be a special value indicating that the access is made by the NCR-MT.

In step S12, the NCR-MT 520A (controller 523) starts a random access procedure for the gNB 200. In the random access procedure, the NCR-MT 520A (transmitter 522) transmits a random access preamble (Msg1) and an RRC message (Msg3) to the gNB 200. In the random access procedure, the NCR-MT 520A (receiver 521) receives a random access response (Msg2) and an RRC message (Msg4) from the gNB 200.

In step S13, when establishing wireless connection with the gNB 200, the NCR-MT 520A (transmitter 522) may transmit to the gNB 200 NCR-MT information indicating that the own UE is an NCR-MT. For example, during the random access procedure with the gNB 200, the NCR-MT 520A (transmitter 522) includes the NCR-MT information in the message (e.g., Msg1, Msg3, or Msg5) for the random access procedure to transmit to the gNB 200. The gNB 200 (controller 230) can recognize based on the NCR-MT information received from the NCR-MT 520A that the UE 100 that has made the access is the NCR-MT 520A, and exclude from an access restriction target (i.e., accept the access from), for example, the NCR-MT 520A. When the random access procedure is completed, the NCR-MT 520A transitions from the RRC idle state or the RRC inactive state to the RRC connected state.

In step S14, the gNB 200 (transmitter 522) transmits a capability inquiry message to inquire about the capability of the NCR-MT 520A to the NCR-MT 520A. The NCR-MT 520A (receiver 521) receives the capability inquiry message.

In step S15, the NCR-MT 520A (transmitter 522) transmits a capability information message including the NCR capability information to the gNB 200. The capability information message may be an RRC message such as a UE Capability message. The gNB 200 (receiver 220) receives the capability information message. The gNB 200 (controller 230) recognizes the capability of the NCR apparatus 500A based on the received capability information message.

In step S16, the gNB 200 (transmitter 522) transmits to the NCR-MT 520A a configuration message including various configurations relating to the NCR apparatus 500A. The NCR-MT 520A (receiver 521) receives the configuration message. The configuration message is a type of the downlink signaling described above. The configuration message may be an RRC message such as an RRC reconfiguration message.

In step S17, the gNB 200 (transmitter 522) transmits a control indication for designating the operation state of the NCR-Fwd 510A to the NCR-MT 520A. The control indication may be the NCR control signal described above (e.g., L1/L2 signaling). The NCR-MT 520A (receiver 521) receives the control indication. The NCR-MT 520A (controller 523) controls the NCR-Fwd 510A in response to the control indication.

In step S18, the NCR-MT 520A controls the NCR apparatus 500A according to the above configuration (and control indication). Note that the NCR-MT 520A may autonomously control the NCR apparatus 500A without depending on the control indication from the gNB 200. For example, the NCR-MT 520A may autonomously control the NCR apparatus 500A based on a position of the UE 100 and/or information received by the NCR-MT 520A from the UE 100.

### (1.8) Beam Sweeping

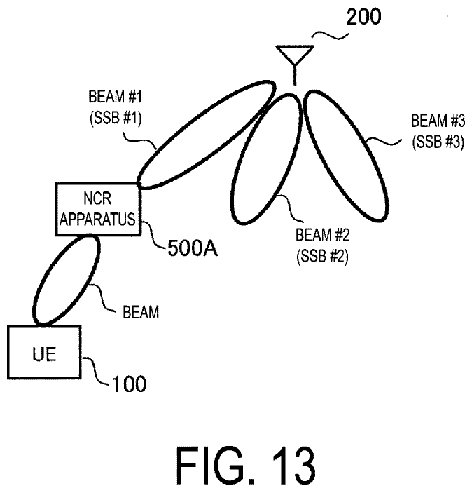

FIG. 13 is a diagram for describing beam sweeping according to the embodiment.

The gNB 200 performs beam sweeping of transmitting beams while sequentially switching the beams in respectively different directions. At this time, the gNB 200 transmits a different SSB per each beam. The SSB is periodically transmitted from the gNB 200 into the cell as an SSB burst including a plurality of SSBs. An SSB index that is an identifier is assigned to each of a plurality of SSBs in one SSB burst. The SSBs are subjected to beamforming and transmitted in respectively different directions. The NCR apparatus 500A (NCR-MT 520A) reports which beam in which direction has had a good reception quality to the gNB 200 during a Random Access CHannel (RACH) procedure. More specifically, the NCR apparatus 500A (NCR-MT 520A) transmits a random access preamble to the gNB 200 at a Random Access CHannel (RACH) occasion associated with an SSB index which has had a good beam reception quality. As a result, the gNB 200 can recognize an optimal beam for the NCR apparatus 500A (NCR-MT 520A).

Note that such an SSB may be transmitted in an initial BWP (initial DL BWP). When the NCR apparatus 500A (NCR-MT 520A) is in an RRC connected state, a dedicated BWP may be configured and activated in the NCR apparatus 500A (NCR-MT 520A). In the dedicated BWP, a Channel State Information Reference Signal (CSI-RS) may be used as a reference signal instead of the SSB. Hereinafter, on the assumption that a beam and an SSB (more specifically, an SSB index) have a one-to-one relationship, an example where beam information for identifying a beam is an SSB index will be mainly described. In this regard, the beam may be associated with the CSI-RS. Beam information for identifying a beam may be a CSI-RS index.

### (1.9) Operation Relating to Load Balancing

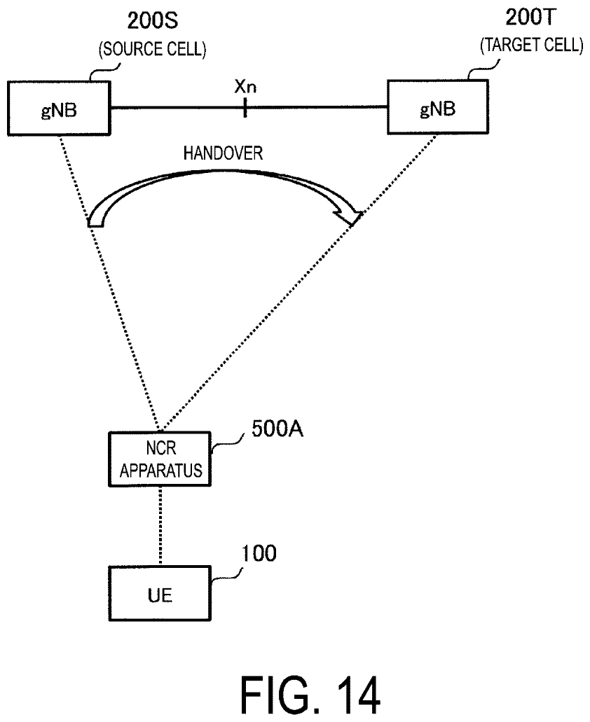

FIG. 14 is a diagram for describing an operation relating to load balancing according to the first embodiment.

The NCR apparatus 500A extends the coverage of the cell of a gNB 200S by relaying radio signals between the gNB 200S and the UE 100. In the illustrated example, the number of UEs 100 connected with the gNB 200S via the NCR apparatus 500A is one, but a plurality of the UEs 100 may be present.

When the coverage is extended by the NCR apparatus 500A, the cell of the gNB 200S needs to accommodate a larger number of UEs. Therefore, the load of the cell of the gNB 200S increases, and an overload is most likely to occur.

Here, by handing over the NCR apparatus 500A from the cell (source cell) of the gNB 200S to the cell (target cell) of a gNB 200T that is a neighboring base station, the load of the cell of the gNB 200S can be balanced with the cell of the gNB 200T. A scenario in which the NCR apparatus 500A is handed over for the purpose of load balancing is mainly assumed below. While not being limited to the handover of the NCR apparatus 500A for the purpose of load balancing, the handover may be performed for the purpose of improvement of a radio condition of the NCR apparatus 500A or the like. Hereinafter, the gNB 200S will be also referred to as the source gNB (source base station) 200S, and the gNB 200T will be also referred to as the target gNB (target base station) 200S

In the first embodiment, the gNB 200S corresponding to a source cell (first cell) transmits a message for connecting the NCR apparatus 500A to a target cell (second cell) to the gNB 200T corresponding to the target cell on the Xn interface (inter-base station interface). The message contains information relating to the NCR apparatus 500A. Thus, the NCR apparatus 500A can be appropriately handed over. Here, the gNB 200S is an example of a first network node, and the gNB 200T is an example of a second network node. The Xn interface is an example of a network interface.

In the following description of the first embodiment, an example where inter-base station handover of the NCR apparatus 500A, more specifically, inter-CU handover is performed will be mainly described. In this regard, the first embodiment is not limited to inter-base station handover and may be intra-base station handover (Intra-CU handover). In a case of intra-base station handover, the first network node may be a CU or a source DU, the second network node may be a target DU, and the network interface may be an F1 interface.

Although a handover operation will be mainly described in the first embodiment, the first embodiment may be applied to a Dual Connectivity (DC) operation in which the NCR apparatus 500A performs simultaneous communication with the gNB 200S and the gNB 200T. In this case, the first network node may be the gNB 200S (master node) and the second network node may be the gNB 200T (secondary node), and the network interface may be the F1 interface and the message may be a secondary node addition request message.

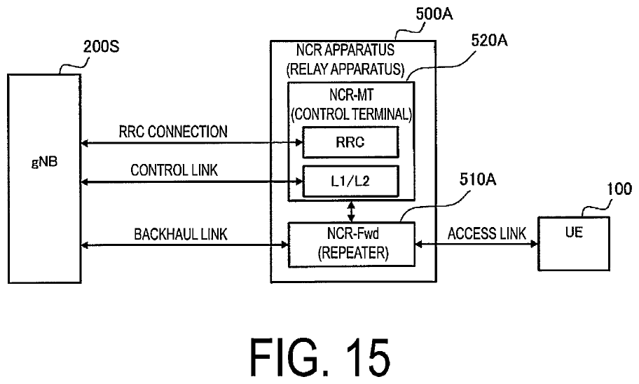

FIG. 15 is a diagram for describing a link (connection) between the NCR apparatuses 500A and the gNB 200S according to the first embodiment.

A backhaul link is established between the gNB 200S and the NCR-Fwd 510A of the NCR apparatus 500A. An access link is established between the UE 100 and the NCR-Fwd 510A of the NCR apparatus 500A. The NCR apparatus 500A (NCR-Fwd 510A) that relays a radio signal transmitted between the gNB 200S and the UE 100 changes a propagation state of the radio signal without demodulating or modulating the radio signal.

A control link is established between the gNB 200S and the layer 1 and/or the layer 2 (L1/L2) of the NCR apparatus 500A (NCR-MT 520A). An RRC connection is established between the gNB 200S and the RRC of the NCR apparatus 500A (NCR-MT 520A). The RRC of the NCR apparatus 500A (NCR-MT 520A) transmits and receives RRC messages relating to handover to and from the gNB 200S via the RRC connection. The NCR apparatus 500A (NCR-MT 520A) switches the RRC connection from the source gNB 200S to the target gNB 200T by handover.

### (1.9.1) First Operation Pattern

According to the first operation pattern, the source gNB 200S notifies the target gNB 200T of a handover request of the NCR apparatus 500A. The source gNB 200S may notify the target gNB 200T of load balancing handover. The source gNB 200S may notify the target gNB 200T of the number of the UEs 100 to be handed over subsequently to the NCR apparatus 500A. Such notification enables the target gNB 200T to appropriately determine whether to accept the handover request from the source gNB 200S.

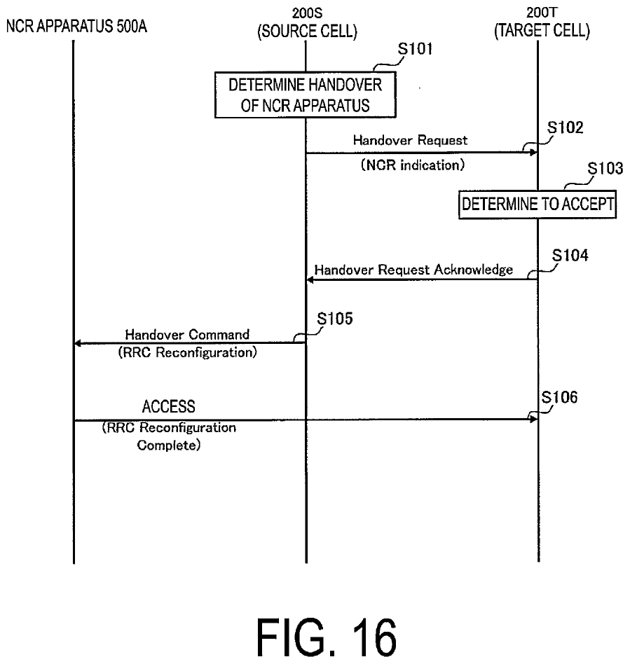

FIG. 16 is a diagram illustrating an operation of the mobile communication system 1 according to the first operation pattern.

In step S101, the source gNB 200S determines the handover of the NCR apparatus 500A. Based on a measurement report message from the NCR apparatus 500A (NCR-MT 520A), the source gNB 200S may determine the handover of the NCR apparatus 500A in response to discovery of a cell having better radio quality. The source gNB 200S may determine to handover the NCR apparatus 500A in response to an increase in load and need of load balancing.

In step S102, the source gNB 200S transmits to the target gNB 200T over the Xn interface a Handover Request message for requesting handover of the NCR apparatus 500A from the source cell of the source gNB 200S to the target cell of the target gNB 200T. The target gNB 200T receives the Handover Request message. The Handover Request message includes at least one selected from the group consisting of pieces of following information (a1) to (c1).
(a1) Information indicating handover of the NCR apparatus 500A (i.e., NCR indication):
This information is flag information indicating that a handover target is the NCR apparatus 500A. This allows the target gNB 200T to perform control such that handover of the NCR apparatus 500A is accepted preferentially over handover of the UE 100. The flag information is defined separately from information indicating that the handover target is an Integrated Access and Backhaul (IAB) node. As described below, when the relay apparatus is an RIS apparatus, the flag information may be information indicating that the handover target is the RIS apparatus. Note that the flag information may be information indicating that a target NCR apparatus or RIS apparatus has been authenticated.
(b1) Information indicating that the NCR apparatus 500A is handed over to balance the load of the source gNB 200S (source cell) with the target gNB 200T (target cell): When the purpose of handover is load balancing, the source gNB 200S includes, in the handover request, information indicating load balancing associated with the NCR apparatus 500A. Thus, the target gNB 200T can determine whether to accept the handover taking the purpose of the handover into account. When the purpose of the handover is due to the movement of the NCR apparatus or the RIS apparatus, the information (b1) may be information indicating the movement of the apparatus or information indicating that the apparatus has movement capability (is of a mobile type).
(c1) Information indicating the number of the UEs 100 to be handed over due to the handover of the NCR apparatus 500A:

The information indicates, for example, the number of the UEs 100 connected with the source gNB 200S via the NCR apparatus 500A. The source gNB 200S may specify the number of the UEs 100 that are communicating with the NCR apparatus 500A by using the same SSB as that of the NCR apparatus 500A as the number of the UEs 100 to be handed over due to the handover of the NCR apparatus 500A. The information may be information on a throughput (and/or the amount of radio resources) required to accommodate the UE 100.

In step S103, the target gNB 200T determines whether the handover request in step S102 can be accepted. That is, the target gNB 200T having received the Handover Request message determines whether to permit the handover of the NCR apparatus 500A based on the information included in the Handover Request message. The target gNB 200T may determine to accept the handover request when the target gNB 200T itself has capability to control the NCR apparatus 500A and/or when the target gNB 200T can keep a load of itself at a certain level or less even if the NCR apparatus 500A and the UE 100 are handed over to target gNB 200T. Here, the description continues on the assumption that the target gNB 200T accepts (permits) the handover request.

In step S104, the target gNB 200T transmits to the source gNB 200S over the Xn interface a Handover Request Acknowledge message that is a response message indicating that handover is permitted. The source gNB 200S receives the Handover Request Acknowledge message. The target gNB 200T may include in the Handover Request Acknowledge message an indication as to whether the NCR apparatus 500A (NCR-MT 520A) also continues to operate under control of the source gNB 200S during handover. The indication may be an indication as to whether to continue the operation under current control after the handover.

In step S105, the source gNB 200S transmits an RRC Reconfiguration message including the information in the Handover Request Acknowledge message, i.e., a Handover Command for indicating handover to the target gNB 200T (target cell) to the NCR apparatus 500A (NCR-MT 520A). The NCR apparatus 500A (NCR-MT 520A) receives the Handover Command. The Handover Command may include the indication included in the Handover Request Acknowledge message in step S104.

In step S106, the NCR apparatus 500A (NCR-MT 520A) starts accessing the target gNB 200T (target cell) designated by the Handover Command in response to reception of the Handover Command in step S105. The NCR apparatus 500A (NCR-MT 520A) may transmit the RRC Reconfiguration Complete message to the target gNB 200T (target cell) at the time of the access. The NCR apparatus 500A (NCR-MT 520A) may also continue to control the NCR apparatus 500A (NCR-Fwd 510A) during the handover according to the indication included in the Handover Command.

### (1.9.2) Second Operation Pattern

As described above, when control of the NCR apparatus 500A is transferred to another cell (target cell) by handover, it is desirable that the another cell can more quickly and accurately control the NCR apparatus 500A after the handover. According to the second operation pattern, the source gNB 200S notifies the target gNB 200T of control information and/or context information of the NCR apparatus 500A. That is, according to the second operation pattern, the Handover Request message includes the control information used for control of the NCR apparatus 500A and/or the context information of the NCR apparatus 500A. Thus, the target gNB 200T can more quickly and accurately control the NCR apparatus 500A after handover. Note that the second operation pattern may be performed in combination with the above described first operation pattern.

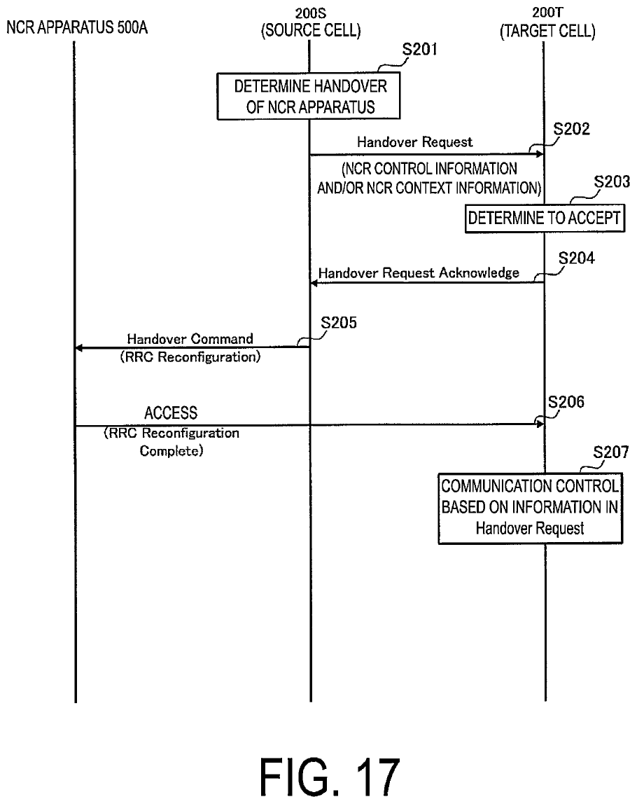

FIG. 17 is a diagram illustrating the operation of the mobile communication system 1 according to the second operation pattern. Redundant description of operations that overlap the operations of the first operation pattern described above will be omitted.

In step S201, the source gNB 200S determines handover of the NCR apparatus 500A.

In step S202, the source gNB 200S transmits to the target gNB 200T over the Xn interface a Handover Request message for requesting handover of the NCR apparatus 500A from the source cell of the source gNB 200S to the target cell of the target gNB 200T. The target gNB 200T receives the Handover Request message. The Handover Request message includes at least one selected from the group consisting of pieces of following information (a2) to (c2).
(a2) Control information (beam information) indicating a beam to be applied to the NCR apparatus 500A:
The control information may include an SSB index applied to the NCR apparatus 500A by itself. In this case, the target gNB 200T may estimate an optimal beam to be applied to the NCR apparatus 500A by itself from, for example, the SSB index and the measurement report message of the UE 100 currently served by the target gNB 200T. The control information may include an SSB index that the target cell needs to apply. The source gNB 200S may specify the SSB index from, for example, the measurement report message of the NCR apparatus 500A (NCR-MT 520A).
(b2) Control information for controlling the operation of the NCR apparatus 500A: The control information includes NCR control information corresponding to the NCR control signal described above, the NCR control information including at least one selected from the group consisting of a weight, an (output) beam angle, and a transmission output (gain) applied by the source gNB 200S to the NCR apparatus 500A. The control information may include control time information that indicates a time (timing) at which the NCR control information is applied. For example, the target gNB 200T may estimate that many UEs 100 are present in the direction of the most frequently used beam control configuration, which may be referenced when the target gNB 200T itself controls the NCR apparatus 500A.
(c2) Context information of the NCR apparatus 500A: The context information includes, for example, information indicating that the operation of the NCR apparatus 500A has been authenticated from the network (a core network, a radio access network, and/or a network monitoring apparatus).

In step S203, the target gNB 200T determines whether the handover request in step S102 can be accepted. Here, the description continues on the assumption that the target gNB 200T accepts (permits) the handover request.

The operations in step S204 to step S206 are the same as and/or similar to those of the first operation pattern described above.

In step S207, after the NCR apparatus 500A connects to a cell (target cell) of the target gNB 200T, the target gNB 200T performs communication control on the NCR apparatus 500A based on the information included in the Handover Request message in step S202.

### (1.9.3) Third Operation Pattern

An operation of handing over the UE 100 as well due to the handover of the NCR apparatus 500A will be described according to the third operation pattern. According to the third operation pattern, the source gNB 200S configures Conditional HandOver (CHO) for the UE 100, and thereby implements the handover of the UE 100 due to the handover of the NCR apparatus 500A.

According to CHO, the source gNB 200S transmits in advance a handover request to a candidate gNB that manages a candidate cell that is a target cell candidate, and transmits configuration information of CHO to the UE 100 in advance. The UE 100 suspends the handover until a trigger condition designated by the configuration information is satisfied after receiving the configuration information, and starts the handover when the trigger condition is satisfied. The trigger condition may be that radio quality of a candidate cell becomes higher than a threshold value. The trigger condition may be that the radio quality of the candidate cell becomes higher than radio quality of the serving cell (source cell).

According to the third operation pattern, the source gNB 200S, the source gNB 200S transmits to the target gNB 200T a UE handover request for requesting CHO of the source UE 100. Here, the source gNB 200S notifies the target gNB 200T that the CHO is caused by the handover of the NCR apparatus 500A. That is, when requesting the target gNB 200T to perform CHO of the relevant UE 100, the source gNB 200S notifies the target gNB 200T that the request is due to the handover of the NCR apparatus 500A. The source gNB 200S may request the target gNB 200T to perform handover of the group of the NCR apparatus 500A and the user equipment by including the UE handover request in the Handover Request message for requesting handover of the NCR apparatus 500A. Note that the second operation pattern may be performed in combination with the above described first operation pattern.

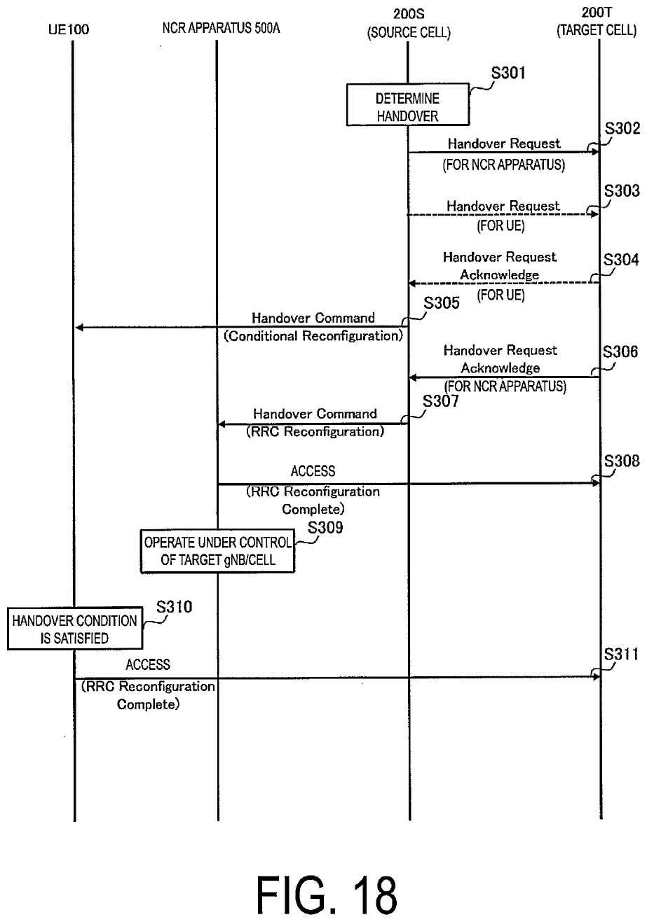

FIG. 18 is a diagram illustrating the operation of the mobile communication system 1 according to the third operation pattern. Redundant description of operations that overlap the operations of the first operation pattern described above will be omitted.

In step S301, the source gNB 200S determines handover of the NCR apparatus 500A.

In step S302, the source gNB 200S, the source gNB 200S transmits, to the target gNB 200T over the Xn interface, a Handover Request message for requesting handover of the NCR apparatus 500A from the source cell of the source gNB 200S to the target cell of the target gNB 200T. Here, the source gNB 200S designates normal handover that is not CHO. The target gNB 200T receives the Handover Request message.

The Handover Request message may include information indicating that the Handover Request message of the UE 100 is subsequently transmitted from the source gNB 200S. In this case, the target gNB 200T may suspend transmission of a response (HO Request Ack) in response to the handover request of the NCR apparatus 500A (i.e., determination on whether the handover can be accepted) until the target gNB 200T receives the Handover Request message of the UE 100.

In a case of group handover, the Handover Request message may include, as an information element, a handover request (Handover Request message) of the UE 100 to be subsequently handed over. The handover request includes information on the UE 100 (such as UE context information). When a plurality of UEs 100 to be subsequently handed over are present, the Handover Request message may include the handover request of the plurality of UEs in a list format. By including the handover request of the UE 100 in the handover request of the NCR apparatus 500A, the handover (i.e., group handover) can be controlled based on a unit of group of the NCR apparatus 500A and the UEs 100. In this case, step S303 and step S304 to be described below may be unnecessary.

While not being group handover, in step S303, the source gNB 200S transmits a Handover Request message (Conditional Reconfiguration request) of the UE 100 to the target gNB 200T over the Xn interface. The message may include information for identifying the handover request of the NCR apparatus 500A in step S302. The target gNB 200T can recognize a handover timing of the corresponding NCR apparatus 500A (a transmission timing of the Handover Command and an access timing of the NCR apparatus 500A) from the information. The target gNB 200T may perform an efficient operation of, for example, preparing resources for access of the UE 100 after access of the NCR apparatus 500A is completed.

When not being group handover and handing over a plurality of UEs 100, the source gNB 200S may transmit a plurality of Handover Request messages associated with the plurality of UEs 100 to the target gNB 200T. The source gNB 200S may include information indicating that the message is the last message in the last Handover Request message among the plurality of these Handover Request messages. This information enables the target gNB 200T to recognize the number of HOs of the UE 100 due to the handover of the NCR apparatus 500A. The target gNB 200T may determine whether a series of handover requests can be accepted and return HO Request Ack of the UEs 100 and the NCR apparatus 500A.

In step S304, the target gNB 200T transmits a response (Handover Request Acknowledge) message in response to the handover request of the UE 100 in step S303 to the source gNB 200S over the Xn interface. The message includes RRC Reconfiguration (Conditional Reconfiguration) to be configured for the UE 100. Note that, in the case of group handover, the target gNB 200T may collectively transmit to the source gNB 200S the response in response to the handover request of the NCR apparatus 500A and the response in response to the handover request of the UE 100.

In step S305, the source gNB 200S transmits a Handover Command including the RRC Reconfiguration (Conditional Reconfiguration) to the UE 100. The UE 100 receives the Handover Command, and starts determining whether the trigger condition of the CHO has been satisfied.

In step S306, the target gNB 200T transmits a response (Handover Request Acknowledge) message in response to the handover request of the NCR apparatus 500A to the source gNB 200S over the Xn interface. The source gNB 200S receives the Handover Request Acknowledge message. In the case of group handover, the target gNB 200T may include, in the message, Handover Request Acknowledge (possibly a plurality of Handover Request Acknowledges) of the UE 100 described above.

In step S307, the source gNB 200S transmits to the NCR apparatus 500A (NCR-MT 520A) a Handover Command for indicating normal handover that is not CHO.

In step S308, the NCR apparatus 500A (NCR-MT 520A) accesses the target cell (target gNB 200T).

In step S309, the NCR apparatus 500A starts operating under control of the target gNB 200T (target cell). At this point of time, in the coverage of the NCR apparatus 500A, a signal of the source cell is not relayed, and the signal of the target cell is relayed.

As a result, in step S310, the trigger condition of CHO configured for the UE 100 is satisfied.

In step S311, in response to the trigger condition of the CHO being satisfied, the UE 100 executes corresponding conditional reconfiguration and starts accessing the target cell (target gNB 200T).

### (2) Second Embodiment

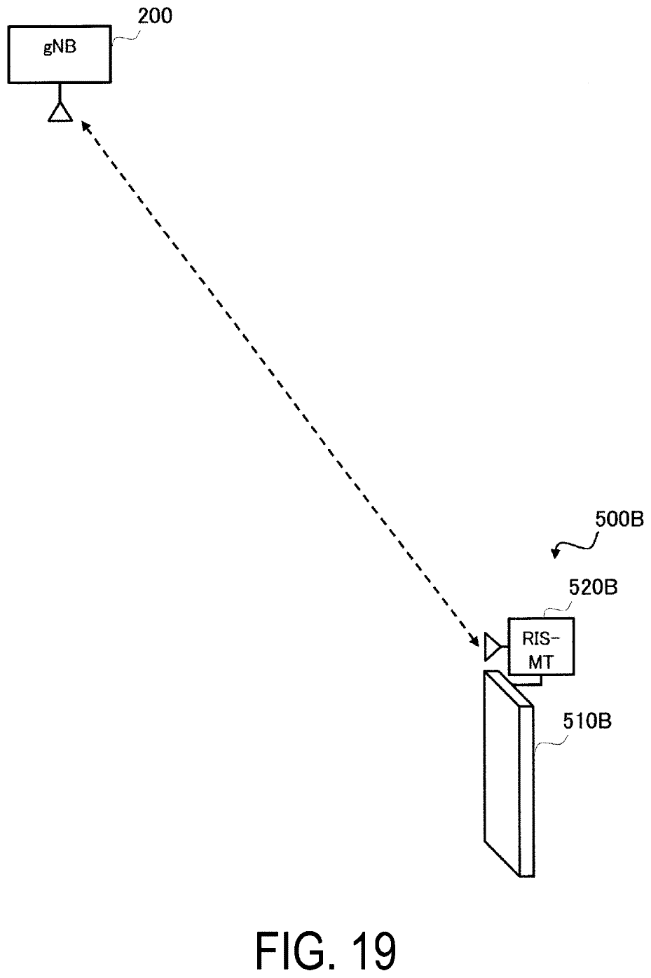

A difference of a second embodiment from the first embodiment described above will be mainly described. As illustrated in FIG. 19, a relay apparatus according to the second embodiment is a Reconfigurable Intelligent Surface (RIS) apparatus 500B that changes a propagation direction of an incident radio wave (radio signal) by reflection or refraction. The “NCR” in the first embodiment described above may be read as the “RIS”.

The RIS is one type of a repeater (hereinafter also referred to as a “RIS-Fwd”) that can perform beamforming (directivity control) in the same and/or similar way as that of the NCR by changing the characteristics of metamaterials. The RIS may be able to change a range (distance) of a beam by controlling a reflection direction and/or a refraction direction of each unit element. For example, the RIS may have a configuration capable of controlling the reflection direction and/or refraction direction of each unit element, and focusing on a near UE (directing a beam) or focusing on a far UE (directing a beam).

The RIS apparatus 500B includes a new UE (hereinafter referred to as an “RIS-MT”) 520B that is a control terminal for controlling a RIS-Fwd 510B. The RIS-MT 520B controls the RIS-Fwd 510B in cooperation with the gNB 200 by establishing wireless connection with the gNB 200 and performing wireless communication with the gNB 200. The RIS-Fwd 510B may be a reflective RIS. This RIS-Fwd 510B reflects an incident radio wave and thereby changes the propagation direction of the radio wave. Here, a reflection angle of the radio wave can be variably configured. The RIS-Fwd 510B reflects radio waves incident from the gNB 200 toward the UE 100. The RIS-Fwd 510B may be a transmissive RIS. This RIS-Fwd 510B refracts an incident radio wave and thereby changes the propagation direction of the radio wave. Here, a refraction angle of the radio wave can be variably configured.

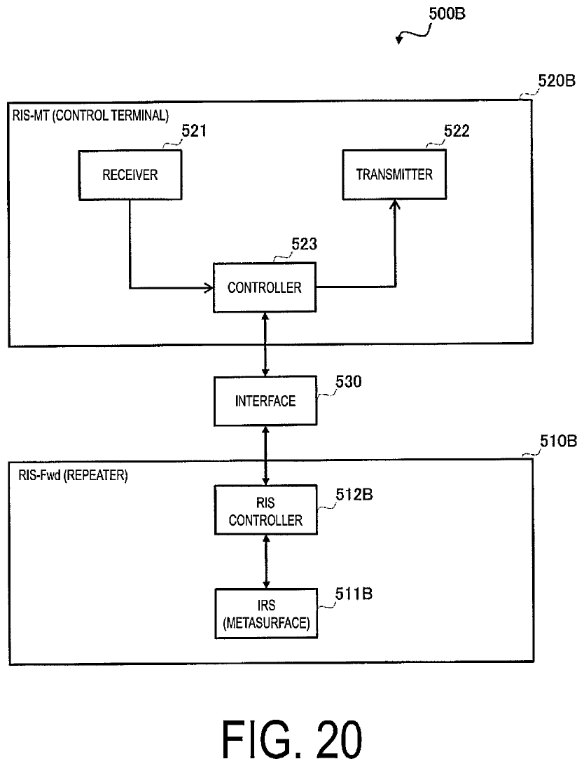

FIG. 20 is a diagram illustrating configuration examples of the RIS-Fwd (repeater) 510B and the RIS-MT (control terminal) 520B according to the second embodiment. The RIS-MT 520B includes a receiver 521, a transmitter 522, and a controller 523. Such a configuration is the same as and/or similar to that in the first embodiment described above. The RIS-Fwd 510B includes an RIS 511B and an RIS controller 512B. The RIS 511B is a metasurface configured using metamaterials. For example, the RIS 511B is configured by installing very small structures in an array form with respect to a wavelength of a radio wave, and a direction and/or a beam shape of a reflected wave can be arbitrarily designed by forming the structures in different shapes depending on a disposition place. The RIS 511B may be a transparent dynamic metasurface. The RIS 511B may be configured by stacking a transparent glass substrate on a metasurface substrate on which a large number of small structures are installed in a regular form and that is made transparent, and may be capable of dynamically controlling three patterns of a mode of transmitting an incident radio wave, a mode of transmitting a part of a radio wave and reflecting a part thereof, and a mode of reflecting all radio waves by minutely moving the stacked glass substrate. The RIS controller 512B controls the RIS 511B in response to an RIS control signal from the controller 523 of the RIS-MT 520B. The RIS controller 512B may include at least one processor and at least one actuator. The processor interprets the RIS control signal from the controller 523 of the RIS-MT 520B and drives the actuator according to the RIS control signal.

### (3) Other Embodiments

The operation flows described above can be not only separately and independently implemented, but also implemented by combining two or more of the operation flows. For example, some steps of one operation flow may be added to another operation flow or some steps of one operation flow may be replaced with some steps of another operation flow. In each flow, all steps need not to be necessarily executed, and only some of the steps may be executed.

In the embodiments described above, an example where the base station is an NR base station (gNB) has been described. However, the base station may be an LTE base station (eNB). The base station may be a relay node such as an Integrated Access and Backhaul (IAB) node. The base station may be a Distributed Unit (DU) of the IAB node.

A program that causes a computer to execute each processing performed by the UE 100 (the NCR-MT 520A and the RIS-MT 520B) or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing each processing performed by the UE 100 or the gNB 200 may be integrated, and at least a part of the UE 100 or the gNB 200 may be implemented as a semiconductor integrated circuit (chipset, System on a chip (SoC)).

The phrases “based on” and “depending on/in response to” used in the present disclosure do not mean “based only on” and “only depending on/in response to”, unless specifically stated otherwise. The phrase “based on” means both “based only on” and “based at least in part on”. Similarly, the phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variation can be made without departing from the gist of the present disclosure.

### (4) Supplementary Note

Features relating to the embodiments described above are described below as supplements.

### Supplementary Note 1

A communication method used in a mobile communication system includes:
at a relay apparatus, relaying a radio signal, the relay apparatus being configured to change a propagation state of the radio signal without demodulating and modulating the radio signal transmitted between a first cell and a user equipment; and
at a first network node corresponding to the first cell, transmitting a message for connecting the relay apparatus to a second cell to a second network node corresponding to the second cell over a network interface, and
the message includes information relating to the relay apparatus.

### Supplementary Note 2

According to the communication method described in Supplementary Note 1,
the first network node is a first base station,
the second network node is a second base station, and
the network interface is an inter-base station interface.

### Supplementary Note 3

According to the communication method described in Supplementary Note 2, the message is a handover request message for requesting handover of the relay apparatus from the first cell to the second cell.

### Supplementary Note 4

According to the communication method described in Supplementary Note 3, the handover request message includes information indicating the handover of the relay apparatus.

### Supplementary Note 5

According to the communication method described in Supplementary Note 3 or 4, the handover request message includes information indicating that the relay apparatus is handed over to balance a load of the first base station with the second base station.

### Supplementary Note 6

According to the communication method described in any one of Supplementary Notes 3 to 5, the handover request message includes information indicating the number of user equipments to be handed over due to the handover of the relay apparatus.

### Supplementary Note 7

The communication method described in any one of Supplementary Notes 3 to 6 further includes:
at the second base station having received the handover request message, determining based on the information included in the handover request message whether to permit the handover of the relay apparatus;
at the second base station, transmitting to the first base station a response message indicating that the handover is permitted when permitting the handover of the relay apparatus; and
at the first base station having received the response message, transmitting a handover command to the relay apparatus.

### Supplementary Note 8

According to the communication method described in any one of Supplementary Notes 3 to 7, the handover request message includes control information used for control of the relay apparatus and/or context information of the relay apparatus.

### Supplementary Note 9

According to the communication method described in Supplementary Note 8, the control information includes information indicating a beam to be applied to the relay apparatus and/or information for controlling an operation of the relay apparatus.

### Supplementary Note 10

The communication method described in Supplementary Note 8 or 9 further includes the step of, at the second base station having received the handover request message, performing communication control on the relay apparatus based on the information included in the handover request message after the relay apparatus connects to the second cell.

### Supplementary Note 11

According to the communication method described in any one of Supplementary Notes 3 to 10, the first base station is configured to transmit to the second base station a user equipment handover request for requesting conditional handover of the user equipment from the first cell to the second cell, and
the step of transmitting the user equipment handover request includes the step of notifying the second base station of that the conditional handover is due to the handover of the relay apparatus.

### Supplementary Note 12

According to the communication method described in Supplementary Note 11, the first base station is configured to request the second base station to perform handover of a group of the relay apparatus and the user equipment by including the user equipment handover request in the handover request message for requesting the handover of the relay apparatus.

### Supplementary Note 13

A network node that corresponds to a first cell in a mobile communication system includes a transmitter configured to transmit a message to a second network node corresponding to a second cell over a network interface, the message being for connecting, to the second cell, a relay apparatus configured to change a propagation state of a radio signal without demodulating and modulating the radio signal transmitted between the first cell and a user equipment, and the message includes information relating to the relay apparatus.

### REFERENCE SIGNS

1: Mobile communication system
100: UE
200: gNB
210: Transmitter
220: Receiver
230: Controller
240: Backhaul communicator
500A: NCR apparatus
510A: NCR-Fwd
520A: NCR-MT
500B: RIS apparatus
511A: Wireless unit
511a: Antenna
511b: RF circuit
511c: Directivity controller
512A: NCR controller
512B: RIS controller
521: Receiver
522: Transmitter
523: Controller
530: Interface

1. A communication method used in a mobile communication system, the communication method comprising:
at a relay apparatus, relaying a radio signal, the relay apparatus being configured to change a propagation state of the radio signal without demodulating and modulating the radio signal transmitted between a first cell and a user equipment; and
at a first network node corresponding to the first cell, transmitting a message for connecting the relay apparatus to a second cell to a second network node corresponding to the second cell over a network interface,
wherein the message includes information relating to the relay apparatus.

2. The communication method according to claim 1, wherein
the first network node is a first base station,
the second network node is a second base station, and
the network interface is an inter-base station interface.

3. The communication method according to claim 2, wherein the message is a handover request message for requesting handover of the relay apparatus from the first cell to the second cell.

4. The communication method according to claim 3, wherein the handover request message comprises information indicating the handover of the relay apparatus.

5. The communication method according to claim 3, wherein the handover request message comprises information indicating that the relay apparatus is handed over to balance a load of the first base station with the second base station.

6. The communication method according to claim 3, wherein the handover request message comprises information indicating the number of user equipments to be handed over due to the handover of the relay apparatus.

7. The communication method according to claim 3, further comprising:
at the second base station having received the handover request message, determining based on the information comprised in the handover request message whether to permit the handover of the relay apparatus;
at the second base station, transmitting to the first base station a response message indicating that the handover is permitted when permitting the handover of the relay apparatus; and
at the first base station having received the response message, transmitting a handover command to the relay apparatus.

8. The communication method according to claim 3, wherein the handover request message comprises control information used for control of the relay apparatus and/or context information of the relay apparatus.

9. The communication method according to claim 8, wherein the control information comprises information indicating a beam to be applied to the relay apparatus and/or information for controlling an operation of the relay apparatus.

10. The communication method according to claim 8, further comprising, at the second base station having received the handover request message, performing communication control on the relay apparatus based on the information comprised in the handover request message after the relay apparatus connects to the second cell.

11. The communication method according to claim 3, wherein
the first base station is configured to transmit to the second base station a user equipment handover request for requesting conditional handover of the user equipment from the first cell to the second cell, and
the transmitting the user equipment handover request comprises notifying the second base station that the conditional handover is due to the handover of the relay apparatus.

12. The communication method according to claim 11, wherein the first base station is configured to request the second base station to perform handover of a group of the relay apparatus and the user equipment by including the user equipment handover request in the handover request message for requesting the handover of the relay apparatus.

13. A network node that corresponds to a first cell in a mobile communication system, the network node comprising:
a transmitter configured to transmit a message to a second network node corresponding to a second cell over a network interface, the message being for connecting, to the second cell, a relay apparatus configured to change a propagation state of a radio signal without demodulating and modulating the radio signal transmitted between the first cell and a user equipment,
wherein the message includes information relating to the relay apparatus.
